(19) United States
(12) Patent Application Publication
(10) Pub. No.: US 2007/0170739 A1
(43) Pub. Date: Jul. 26, 2007

(54) AUXILIARY STORAGE SYSTEM FOR AUTOMOTIVE VEHICLE

(75) Inventor: Emil Sims, Northville, MI (US)

Correspondence Address: ARTZ & ARTZ, P.C., 28333 TELEGRAPH ROAD, SUITE 250, SOUTHFIELD, MI, 48034, US

(73) Assignee: FORD GLOBAL TECHNOLOGIES, LLC, Dearborn, MI (US)

(21) Appl. No.: 11/307,186

(22) Filed: Jan. 26, 2006

(51) Int. Cl. B62D 33/08

(52) U.S. Cl. 296/26.11

(57) ABSTRACT

An auxiliary storage system for an automotive vehicle includes a movable unshaped bulkhead adapted to be carried upon a load floor of a vehicle, a movable cover for engaging an upper portion of the bulkhead, and a lock mechanism for selectively locking the removable cover to the bulkhead.

### TECHNICAL FIELD

The present invention related to an auxiliary storage system for extending and enlarging the storage space within a vehicle such as a sport utility vehicle or pickup truck.

### BACKGROUND

Utility-oriented vehicles, such as sport utility vehicles and pickup trucks, are frequently used by drivers to transport larger, more bulky items. Some items transported by active lifestyle drivers are, of course, quite long in length, such as bicycles and skis. Although it is desirable to have the capability to extend the storage space of a vehicle to include the tailgate of either a pickup-type box or an SUV bed with a tailgate, such extension devices have typically been lacking in security inasmuch as they lack means for locking the device or bed extender so as to prevent contents from being pilfered. U.S. Pat. Nos. 2,712,470 and 6,742,822 are two examples of pickup bed extenders which, although expanding the load-carrying capability of the truck's tailgate, generally do so at the expense of cargo security.

A system and method according to the present invention provide secure, additional storage for a SUV or pickup-type vehicle.

### SUMMARY OF THE INVENTION

An auxiliary storage system for an automotive vehicle includes a movable bulkhead adopted to be carried upon the vehicle's load floor, and a moveable cover for engaging an upper portion of the bulkhead.

A lock mechanism is used to selectively lock the removable cover to the bulkhead. A movable bulkhead according to the present invention preferably includes a generally U-shaped wall having an enclosed end adapted for orientation toward an open end of the vehicle's load area. The load area is defined at least in part by a load floor. The present movable bulkhead is preferably fabricated from plastics material or other lightweight formable, corrosion and impact resistant material.

A movable cover according to the present invention may include a cover mounted to a wall surrounding a load floor upon which the movable bulkhead rests, with the cover having at least one latch for engaging the movable bulkhead. The cover may include one or more stationary sections mounted to the wall surrounding the load floor, and at least one telescoping section extending from one of the stationary sections and having a latch for engaging and locking the cover to the movable bulkhead.

According to another aspect of the present invention, an automotive vehicle includes a chassis, a load floor mounted upon the chassis, a wall circumscribing at least a portion of the load floor, a movable bulkhead for enclosing a portion of the load floor not circumscribed by the wall, and a movable cover mounted to the wall and having a selectively deployable section for engaging the movable bulkhead.

According to another aspect of the present invention, a method for expanding a walled storage space of an automotive vehicle includes the steps of placing a generally U-shaped movable bulkhead upon a load floor within the vehicle, so as to extend a wall circumscribing at least a portion of the load floor, and extending and locking at least one section of a selectively deployable movable cover upon the movable bulkhead.

It is an advantage of a system according to the present invention that the usual storage space within the bed of a pickup truck or similar vehicle may be expanded, while at the same time maintaining a more compact vehicle for use when expanded storage is not required.

It is a further advantage of a system according to present invention that the expanded storage is secure underneath a lockable cover.

It is yet another advantage of a system according to the present invention that longer items such as skis and bicycles may be carried in a locked compartment while being protected from the elements.

Other advantages, as well as features and objects of the present invention will become apparent to the reader of this specification.

### BRIEF DESCRIPTION OF THE DRAWINGS

FIG. 1 is a perspective view of a vehicle having an auxiliary storage system according to the present invention.

FIG. 2 shows a portion of the vehicle depicted in FIG. 1, with the auxiliary storage system in a partially closed position.

FIG. 3 illustrates a vehicle with a storage system according to the present invention in a non-deployed, or stored, position.

FIG. 4 is a plan view of a portion of FIG. 1 showing the present auxiliary storage system in a closed and locked position.

### DETAILED DESCRIPTION OF THE PREFERED EMBODIMENTS

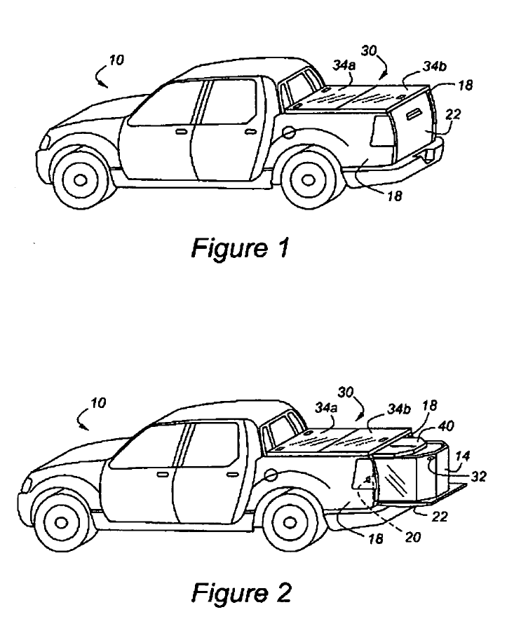

As shown in FIGS. 1 and 2, vehicle 10 has a hinged tailgate, 22, which encloses the end portion of a bed defined by sidewalls 18. Movable cover 30, having sections 34a and 34b, is positioned so as to close the upper portion of the vehicle's bed. Thus, when vehicle 10 is configured as in FIG. 1, there is no external indication of any additional secure storage. Movable bulkhead 14 is shown in FIG. 2 as being carried at least partly upon tailgate 22. In this regard, tailgate 22 functions as a portion of the load floor of vehicle 10. It is also notable from FIGS. 1 and 2 that telescoping section 40 of movable cover 30, which is placed over and locked upon an upper portion of movable bulkhead 14, is completely stored within section 34b of cover 30 when movable bulkhead 14 is in the stored position shown in FIG. 1.

FIG. 2 shows movable cover 30 as having two stationary sections, 34a and 34b, which are mounted conventionally and although removable, are viewed as being stationary for the purposes of the present invention. Telescoping section 40 is shown as being housed within stationary section 34b, so that, as shown in FIG. 2, telescoping section 40 maybe slid out over movable bulkhead 14 and locked into bulkhead 14. Locking of telescoping section 40 of movable cover 30 to movable bulkhead 14 is accomplished as shown in FIG. 4, by means of lock mechanism 24. Locking handle 28 operates slide bolts 26 which pass through apertures 32 in movable bulkhead 14. When lock mechanism 24 has been set, neither telescoping section 40 nor, for that matter, movable bulkhead 14, may be displaced or otherwise moved as to allow access to any contents of the bed of vehicle 10.

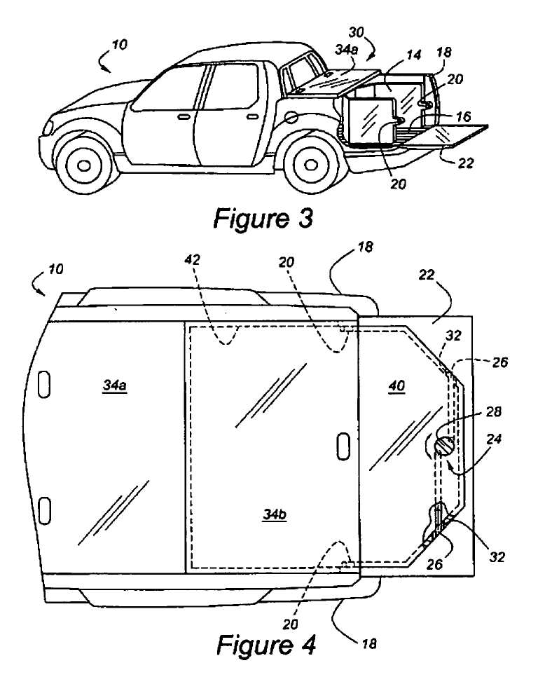

FIG. 3 illustrates the present system in a stowed position, in which tailgate 22 is in an upright, closed, position and movable bulkhead 14 has been rotated about hinge points, or pivots, 20, which are shown also in FIG. 4, into a forward position on load floor 16. This rotation about a generally horizontal axis eliminates the necessity to remove movable bulkhead 14 from vehicle 10 in order to stow bulkhead 14. Similarly, it is not necessary to remove telescoping section 40 of movable cover 30 in order to store telescoping section 40.

According to another aspect of the present invention, a method of providing auxiliary storage within a walled storage space of a vehicle includes placing unshaped bulkhead 14 upon an extension of load floor 16 provided by tailgate 22, and extending and locking telescoping section 40 of pickup box cover 30 upon movable bulkhead 14. Bulkhead 14 may be constructed from plastics material, or metallic materials, or composites, or in other materials known to those skilled in the art and suggested by this disclosure. FIG. 4 further shows that telescoping section 40 is housed within pocket 42 formed in cover section 34b. In addition to providing convenient storage for telescoping section 40, this mode of storage prevents damage to section 40 during stowage.

Although the present invention has been described in connection with particular embodiments thereof, it is to be understood that various modifications, alterations, and adaptations may be made by those skilled in the art without departing from the spirit and scope of the invention set forth in the following claims. For example, the present system could be employed with an SUV having an enclosed rear compartment and a horizontally folding tailgate. Also, depending upon the design constraints applicable to any particular vehicle in which the present auxiliary storage system is being employed, bulkhead 14 could be slidably movable from its stowed position to its deployed position.

What is claimed is:

1. An auxiliary storage system for an automotive vehicle, comprising:
a movable bulkhead adapted to be carried upon a load floor of a vehicle;
a movable cover for engaging an upper portion of said bulkhead; and
a lock mechanism for selectively locking said movable cover to said bulkhead.

2. An auxiliary storage system according to claim 1, wherein said movable bulkhead comprises a generally unshaped wall having a closed end adapted for orientation toward an open end of a load area defined at least in part by said load floor.

3. An auxiliary storage system according to claim 2, wherein said bulkhead is fabricated from plastics material.

4. An auxiliary storage system according to claim 2, wherein said bulkhead is fabricated from metallic material.

5. An auxiliary storage system according to claim 2, wherein said bulkhead is fabricated from composite material.

6. An auxiliary storage system according to claim 1, wherein said movable cover comprises a cover mounted to a wall surrounding a load floor and having at least one latch for engaging said movable bulkhead.

7. An auxiliary storage system according to claim 1, wherein said movable cover comprises a cover mounted to a wall surrounding a load floor and having at least one telescoping section with a latch for engaging said movable bulkhead.

8. An auxiliary storage system according to claim 1, wherein said movable cover comprises a cover having a plurality of stationary sections mounted to a wall surrounding a load -floor and having at least one telescoping section extending from one of said stationary sections and having a latch for engaging and locking to said movable bulkhead.

9. An automotive vehicle, comprising:
a chassis;
a load floor mounted upon said chassis;
a wall circumscribing at least a portion of said load floor;
a movable bulkhead for enclosing a portion of said load floor not circumscribed by said wall; and
a movable cover mounted to said wall and having a selectively deployable section for engaging said movable bulkhead.

10. An automotive vehicle according to claim 9, wherein said movable cover comprises at least one stationary section mounted to said wall, and a selectively deployable telescoping section mounted within said stationary section.

11. An automotive vehicle according to claim 9, wherein said load floor comprises a fixed load floor and a hinged tailgate.

12. An automotive vehicle according to claim 9, wherein said movable bulkhead comprises a generally u-shaped wall having a closed end adapted for orientation toward an open end of a load area defined by said load floor and said wall.

13. An automotive vehicle according to claim 9, wherein said movable bulkhead comprises a generally u-shaped wall having a closed end adapted for orientation toward an open end of a load area defined by a fixed portion of said load floor, by a tailgate comprising an extension of said load floor, and further by said wall.

14. An automotive vehicle according to claim 9, wherein said selectively deployable section of said movable cover comprises a latch for engaging and locking said deployable section to said movable bulkhead.

15. An automotive vehicle according to claim 9, wherein said movable bulkhead is hingedly mounted to said wall for rotation about a generally horizontal axis, with said bulkhead being rotatable from a forwardly located stowed position to a rearwardly located deployed position.

16. A method for expanding a walled storage space within an automotive vehicle, comprising the steps of:
placing a generally u-shaped movable bulkhead upon a load floor comprising a foldable tailgate, so as to extend a wall circumscribing at least a portion of said load floor; and
extending and locking at least one section of a selectively deployable movable cover upon said movable bulkhead.

17. A method according to claim 16, wherein said unshaped movable bulkhead is placed upon a load floor within the vehicle by rotating the bulkhead about a generally horizontal axis from a forwardly located stowed position to a rearwardly located deployed position in which the bulkhead extends over at least a portion of said tailgate.
